(19) United States
(12) Patent Application Publication
(10) Pub. No.: US 2018/0331350 A1
(43) Pub. Date: Nov. 15, 2018

(54) PROCESS FOR MANUFACTURING COMPOSITE CONSISTING OF GRAPHENE MONOLITH AND SILICON

(71) Applicant: COMMISSARIAT À L'ÉNERGIE ATOMIQUE ET AUX ÉNERGIES ALTERNATIVES (CEA), Paris (FR)

(72) Inventors: Pascal GENTILE, Voiron (FR); Harish BANDA, Grenoble (FR); Florence DUCLAIROIR, Coublevie (FR)

(21) Appl. No.: 15/976,201

(22) Filed: May 10, 2018

(30) Foreign Application Priority Data
May 10, 2017 (EP) 17 305 530.2

(51) Int. Cl. H01M 4/133; H01M 4/04; H01M 4/1393; H01M 10/0525

(52) U.S. Cl. CPC H01M 4/133; H01M 4/0428; H01M 2004/027; H01M 10/0525; H01M 4/1393

(57) ABSTRACT

Disclosed is a process of manufacturing a chemically reduced graphene oxide/silicon nanowire composite. The formation of the three-dimensional monolith and the chemical reduction of graphene oxide by a reducing agent selected from hydrazine hydrate, ethylene diamine and 1,4-diaminebutane are in one step. Also disclosed is a chemically reduced graphene oxide/silicon nanowire composite that can be obtained by the disclosed process. The composite is a three-dimensional monolith in which the two components are covalently linked each other, having a high degree of reduction with a C/O ratio of 1-50, preferably from 10 to 25, more preferably 16.7, having a porous structure and a high specific surface area of 50-5,000 m²/g, preferably 800-2,500 m²/g, more preferably 1,433 m²/g and having a low resistance to charge transfer from 0.1 to 5 Ω, preferably from 0.3 to 1.5 Ω. Also disclosed is a lithium-ion battery or a supercapacitor including the composite (or monolith).

### FIELD OF INVENTION

The present invention relates to the preparation of graphene hydrogels with high electrical conductivity, particularly suitable for energy storage applications such as lithium-ion batteries or supercapacitors.

The present invention pertains to the field the preparation of graphene and its derivatives by chemical exfoliation and surface functionalization. More specifically, the invention concerns the modification of the graphene/aqueous solvent interface, by reduction and/or grafting of molecules, allowing the formation of graphene macrostructures described in the literature as being graphene hydrogels or foams or monoliths or three-dimensional structures of graphene.

More particularly the invention relates to the process of manufacturing a graphene/silicon nanowire composite, which is a porous, greatly reduced monolith, in which the silicon nanowires are distributed homogeneously in the monolith and in which the two components are closely linked.

### BACKGROUND OF INVENTION

Rising oil prices and the growing concern to find non-polluting energy solutions have led researchers to focus on cleaner and more efficient electrochemical energy systems. Among these systems, lithium-ion batteries combine high energy and power requirements, have no memory effect, have low self-discharge and are maintenance-free. These batteries therefore appear particularly suitable for hybrid vehicles and electric vehicles.

Silicon anodes significantly improve the energy storage capacity of lithium-ion batteries relative to graphite anodes due to their high energy density. However, the insertion of lithium ions into the silicon is accompanied by large variations in the volume of the anode at the time of charging or discharging. The use of silicon electrodes therefore requires the provision of empty space in the batteries, which reduces the energy density and represents a drawback because a high energy density is desired, particularly for compact applications. In addition, these volume variations fracture the silicon and explains low battery life thus prohibiting any marketing.

In order to further improve the performances and stability of the anode, graphene sheets have been used instead of carbon. Graphene with its crumpled structure has great mechanical flexibility and adapts to variations in silicon volume. In addition, graphene, with its high electrical conductivity, facilitates charge transfer reactions. Finally, graphene features a large contact area with silicon.

Graphene with its high electrical conductivity, mechanical flexibility and remarkable theoretical surface also makes it possible to develop high power supercapacitors promising a wide range of applications in electric vehicles, backup devices and large industrial equipment.

Ruoff et al. pioneered the synthesis of chemically modified graphenes. This synthesis is based on the oxidation of a graphite powder to exfoliated graphene oxide which is then reduced. However, the limited exposure of the graphene sheets to the electrolyte, aqueous or organic, gives low specific capacities of 130 and 99 F/g, respectively. This small area of exposure is explained by the reaggregation of hydrophobic graphene sheets due to strong π-π interactions.

Later, Shi et al. have developed self-assembled graphene hydrogels from aqueous solutions of graphene oxide. Two methods of monolith assembly exist which are the hydrothermal treatment of a solution of graphene oxide and the bridging of graphene oxide sheets by reaction with the diamine.

These monoliths of the prior art do not include silicon which improves the energy storage capacity.

Chinese patent CN106531992 describes composite materials used to make battery electrodes and containing silicon particles, phytic acid, a multilayer graphene oxide and carbon nanotubes. Graphene is here in its oxidized form.

Composites of reduced graphene/silicon nanowires exist but generally consist either of deposits of reduced graphene at the end of silicon nanowires that have been obtained by electrochemical etching, or of mechanical mixtures between nanowires, obtained by electrochemical etching and then cleaved from their growth substrate, and reduced graphene.

To improve the penetration of graphene by silicon nanowires, Ren et al., Nanoscale, 2014, 6, 3353-3360 uses a solution of graphene oxide and HAuCl₄ in the presence of a reducing agent, ethylene glycol, which is then placed in an autoclave at 220° C. for few hours. A graphene powder decorated with gold nanoparticles, and not a monolith, is obtained.

Binh Phuong Nhan Nguyen et al., Advanced Energy Materials, 2013, describes the addition of hydrazine hydrate to a solution of graphene oxide. The solution is heated in an oil bath at 100° C. under a condenser cooled with water for 24 hours. The reduced graphene oxide gradually precipitates into a black solid. This solid has a similar structure to that of a reduced graphene oxide powder.

American patent US2016/0043384 describes a process for obtaining a lithium-ion battery anode in which silicon nanowires are integrated in the pores of a reduced graphene foam. This process consists in the preparation of a solution containing silicon nanowires and reduced graphene particles hydrothermally or thermally. This dispersion is deposited on a substrate to form an anode mixture in the form of a wet layer. This mixture is dried and then heated at high temperature. The heat treatment allows removing the non-carbon elements of graphene and thus, concomitantly, the creation of pores in the mixture. However, this process based on a silicon—graphene mixture does not ensure optimum interpenetration of the silicon nanowires in the graphene foam.

The Applicant has carried out extensive research on graphenes and has defined that there is a need for three-dimensional graphene structures, which would allow better percolation of charges and fast ion transfer and which could lead to a homogeneous distribution of robust particles or nanowires, especially silicon. In particular, the Applicant's research led him to believe that there is a need for porous three-dimensional graphene structures in which silicon nanowires could, all at once, be homogeneously distributed and securely grafted, that is to say with a physicochemical link with the graphene foam and be protected by the graphene structure.

### SUMMARY

Thus, the present invention refers to a process of manufacturing a three-dimensional material comprising a monolith of chemically reduced graphene oxide, in which silicon nanowires and gold nanoparticles are dispersed, said process being characterized in that it comprises:
a step (1) for manufacturing a monolith of chemically reduced graphene oxide in which gold nanoparticles are dispersed,
a step (2) for functionalizing said monolith obtained at step (1), in which silicon, preferably under the form of silicon nanowires, are grafted on the surface of said monolith, and for which said monolith is brought to a temperature ranging from 500 to 850° C., preferably from 600 to 800° C., more preferably of about 650° C. in the presence of a silicon gas.

According to one embodiment, the chemically reduced graphene oxide monolith in which gold nanoparticles are dispersed (step 1) is prepared by contacting an aqueous solution of graphene oxide, HAuCl₄ and a reducing agent selected from hydrazine hydrate, ethylene diamine and 1,4-diaminebutane, in a one-step reaction.

According to one embodiment, the functionalization of the chemically reduced graphene oxide monolith in which gold nanoparticles are dispersed (step 2) is carried out by heating said monolith in an LPCVD furnace in the presence of: silicon reactive gas, preferably SiH₄; an additional gas, preferably an acid gas, more preferably HCl; and a carrier gas, preferably hydrogen H₂; at high pressure, preferably from 500 to 1 400 Pa, more preferably from 650 to 940 Pa, more preferably about 800 Pa.

The present invention also refers to a process for the preparation of a chemically reduced graphene oxide monolith by contacting an aqueous solution of graphene oxide with a reducing agent selected from hydrazine hydrate, ethylene diamine and 1,4-diaminebutane, in a one-step reaction.

The present invention also refers to a chemically reduced graphene oxide monolith, obtainable by the process of the invention.

According to one embodiment, the chemically reduced graphene oxide monolith of the invention is characterized in that:
it has a high degree of reduction with a C/O ratio ranging from 1 to 50, preferably from 10 to 25, more preferably about 16.7,
it is porous with a specific surface area ranging from 50 to 5000 m²/g, preferably from 800 to 2500, more preferably about 1433 m²/g,
it has a low resistance to charge transfer ranging from 0.1 to 5Ω, preferably from 0.3 to 1.5Ω, more preferably about 0.62Ω.

According to one embodiment, the pores of the monolith have a diameter of about 1 nanometer to 500 microns.

According to one embodiment, the electrical conductivity of the monolith is from 10 to 2500, preferably from 950 to 1500, more preferably is 1141 S/m.

According to one embodiment, the gravimetric discharge capacity of the monolith is from 1 to 300 F/g, preferably from 10 to 150 F/g, more preferably from about 130 F/g.

The present invention also refers to a lithium-ion battery comprising a monolith of the invention.

The present invention also refers to a supercapacitor comprising a monolith of the invention.

According to one embodiment, the lithium-ion battery or the supercapacitor of the invention, has a capacity retention ranging from 80% to 99%, preferably from 90% to 99%.

According to one embodiment, the lithium-ion battery or the supercapacitor of the invention, has a volumetric discharge capacity ranging from 100 to 500 F/cm³, preferably about 200 F/cm³.

According to one embodiment, the lithium-ion battery or the supercapacitor of the invention, has a power density ranging from 1 to 100 kW/kg, preferably from 10 to 50 kW/kg, more preferably of about 38 kW/kg.

### Definitions

In the present invention, the following terms have the following meanings:
“About”: preceding a figure means plus or less 10% of the value of said figure.
“Cake”: refers to the aggregation of particles into a friable block obtained after filtration of a suspension.
“Closely physicochemically linked” or “securely grafted”: refers to two component linked together by a covalent chemical bond.
“Crosslinking”: refers to the formation of one or more three-dimensional networks.
“CVD”: means “Chemical Vapor Deposition” or chemical vapor deposition.
“Exfoliation”: refers to the detachment of one or more thin layers (“sheets”) on the surface of a solid.
“Functionalization”: means any chemical modification of all or part of a material. According to one embodiment, the term “functionalization” designates the chemical modification of all or part of the composite (or monolith) of the invention. According to one embodiment, the term “functionalization” refers to the grafting by a covalent bond of a chemical compound (such as for example silicon nanowires) on all or part of the composite (or monolith) of the invention. According to one embodiment, the term “functionalization” may designate both the growth of silicon nanowires and their grafting by establishing a covalent bond on the surface of the monolith of the invention; the term “surface” denotes in the present invention the outer surface and/or the surface of the pores of said monolith.
“Homogeneous”: refers to the density of nanowires or nanoparticles in the monolith varies little from one area to another of the monolith.
“LPCVD furnace”: refers to a “Low Pressure Chemical Vapor Deposition” furnace, i.e. a low pressure chemical vapor deposition furnace.
“Macropores”: refers to pores with diameters greater than 50 nm. According to one embodiment, the macropores have a diameter of more than 50 nm to 500000 nm (i.e. 500 microns); preferably greater than 50 nm to 400000 nm, greater than 50 nm to 300000 nm, greater than 50 nm to 200000 nm, greater than 50 nm to 100000 nm, greater than 50 nm to 50000 nm, more than 50 nm to 40000 nm, more than 50 nm to 30000 nm, more than 50 nm to 20000 nm, more than 50 nm to 10000 nm, more than 50 nm to 5000 nm, more than 50 nm to 1000 nm, more than 50 nm to 500 nm, more than 50 nm to 400 nm, more than 50 nm to 300 nm, more than 50 nm to 200 nm, more from 50 nm to 100 nm, from more than 50 nm to 90 nm, from more than 50 nm to 80 nm, from more than 50 nm to 70 nm, or from more than 50 nm to 60 nm. According to one embodiment, the macropores have a diameter of more than 50 nm to 500000 nm (ie 500 microns); preferably from 100 nm to 500000 nm, from 200 nm to 500000 nm, from 300 nm to 500000 nm, from 400 nm to 500000 nm, from 500 nm to 500000 nm, from 600 nm to 500000 nm, from 700 nm to 500000 nm, from 800 nm to 500000 nm, from 900 nm to 500000 nm, from 1000 nm to 500000 nm, from 5000 nm to 500000 nm, from 10000 nm to 500000 nm, from 15000 nm to 500000 nm, from 20000 nm to 500000 nm, from 30000 nm to 500000 nm, from 40000 nm to 500000 nm, from 50000 nm to 500000 nm, from 100000 nm to 500000 nm, from 200000 nm to 500000 nm, from 300000 nm to 500000 nm, or from 400000 nm to 500000 nm.
“Mesopores”: refers to pores with diameters of between 5 and 50 nm. According to one embodiment, the mesopores have a diameter of more than 5 nm to 50 nm; preferably from 10 nm to 50 nm, from 15 nm to 50 nm, from 20 nm to 50 nm, from 25 nm to 50 nm, from 30 nm to 50 nm, from 35 nm to 50 nm, from 40 nm to 50 nm, or from 45 nm to 50 nm; preferably more than 5 nm to 45 nm, more than 5 nm to 40 nm, more than 5 nm to 35 nm, more than 5 nm to 30 nm, more than 5 nm to 25 nm, more than 5 nm to 20 nm, more than 5 nm to 15 nm, or more than 5 nm to 10 nm. According to one embodiment, the mesopores have a diameter of about 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49 or 50 nm.
“Micropores”: refers to pores with diameters of less than 5 nm. According to one embodiment, the micropores have a diameter ranging from more than 0 nm to 5 nm; preferably from 1 nm to 5 nm; more preferably about 1, 2, 3, 4 or 5 nm.
“Monolith”: refers to a three-dimensional structure. In particular, a monolith (also called hydrogel or foam) is not a powder, a sheet or leaf, a mixture, a cake or a viscous paste. According to one embodiment, the term “monolith” refers to a three-dimensional porous structure, preferably a three-dimensional porous structure of graphene oxide or graphene. According to one embodiment, the term “monolith” does not refer to lamellar multi-component structures such as “sandwich” type.
“Percolation”: commonly refers to the passage of a fluid, liquid or gas, through a medium more or less permeable.
“Sheet” refers to a two-dimensional structure having a thickness of less than 100 nm. Multilayer graphenes with up to 300 layers are considered as sheets.

### DETAILED DESCRIPTION

Monolith of the Invention

Thus, an object of the invention concerns graphene or its derivatives, obtainable by the process of the invention under the form of a porous monolith.

According to one embodiment, one object of the invention is a graphene which can be obtained by the process of the invention under the form of a porous monolith, with a high porosity, low density, that it is possible to densify or not according to the invention. According to one embodiment, the composite (monolith) of the invention comprises pores which are micropores, mesopores or macropores. According to one embodiment, an object of the invention is a monolith of graphene oxide, preferably chemically reduced. According to one embodiment, the monolith of graphene oxide, preferably chemically reduced, is obtainable by the method of the invention.

Another object of the invention is a graphene/gold nanoparticles composite that may be obtained by the process of the invention under the form of a porous monolith, wherein the gold nanoparticles are homogeneously dispersed in the monolith. According to one embodiment, the composite (or monolith) of the invention comprises or consists of graphene and gold nanoparticles.

According to one embodiment, the composite (monolith) of the invention is a composite of high porosity, low density, which one can densify or not depending on the use.

According to one embodiment, another object of the invention is a graphene/silicon nanowires composite (monolith) that may be obtained by the process of the invention, which is a porous monolith, wherein the silicon nanowires are homogeneously distributed in the monolith and wherein two components are closely linked, that is to say with a physicochemical link. According to one embodiment, the composite (or monolith) of the invention comprises or consists of graphene and silicon nanowires. According to one embodiment, the composite (or monolith) of the invention comprises or consists of graphene and silicon nanowires, said silicon nanowires being grafted onto graphene. According to one embodiment, grafting refers to a chemical bond, preferably by a covalent bond. According to one embodiment, in the composite (or monolith) of the invention, graphene and silicon nanowires are linked by physical interactions. According to one embodiment, in the composite (or the monolith) of the invention, the silicon nanowires are homogeneously distributed throughout the material, preferably over the entire surface of the pores.

According to one embodiment, the monolith of the invention is in spherical, cubic or a right-hand block.

According to one embodiment, the monolith of the invention further comprises additives.

According to one embodiment, the monolith of the invention has a density of more than 0 to 10 g/cm³, preferably of 0.5 to 5 g/cm³, more preferentially of 0.56 to 1.56 g/cm³. According to one embodiment, the monolith of the invention has a density of about 0.1; 0.2; 0.3; 0.4; 0.5; 0.6; 0.7; 0.8; 0.9; 1; 1.1; 1,2; 1.3; 1.4; 1.5; 1.6; 1.7; 1.8; 1.9 or 2 g/cm³. According to one embodiment, the monolith of the invention has a density of more than 0 to 10 g/cm³, preferably of 0.5 to 5 g/cm³, more preferentially of 0.56 to 1.56 g/cm³ under ambient conditions.

According to one embodiment, the monolith of the invention has a current density of more than 0 to 10 A/g, preferably from 1 to 5 A/g, more preferably about 2 A/g. According to one embodiment, the monolith of the invention has a current density of about 1, 2, 3, 4, 5, 6, 7, 8, 9 or 10 A/g. According to one embodiment, the monolith of the invention has a current density ranging from 1 to 10 A/g, preferably from 1 to 9 A/g, of 1 to 8 A/g, from 1 to 7 A/g, from 1 to 6 A/g, from 1 to 5 A/g, from 1 to 4 A/g, from 1 to 3 A/g, or from 1 to 2 A/g.

According to one embodiment, the monolith of the invention has a gravimetric discharge capacity ranging from 1 to 300 F/g, preferably from 10 to 150 F/g, more preferably of about 130 F/g. According to one embodiment, the monolith of the invention has a gravimetric discharge capacity of about 10, 20, 30, 40, 50, 60, 70, 80, 90, 100, 110, 120, 130, 140, 150, 160, 170, 180, 190, 200, 210, 220, 230, 240, 250, 260, 270, 280, 290 or 300 F/g.

According to one embodiment, the monolith of the invention has a volumetric discharge capacity ranging from 1 to 500 F/cm³, preferably from 100 to 500 F/cm³, more preferably about 200 F/cm³. According to one embodiment, the monolith of the invention has a volumetric discharge capacity of about 1, 10, 20, 30, 40, 50, 60, 70, 80, 90, 100, 110, 120, 130, 140 , 150, 160, 170, 180, 190, 200, 210, 220, 230, 240, 250, 260, 270, 280, 290, 300, 310, 320, 330, 340, 350, 360, 370, 380, 390 , 400, 410, 420, 430, 440, 450, 460, 470, 480, 490 or 500 F/cm³. According to one embodiment, the monolith of the invention has a volumetric discharge capacity of from 1 to 500 F/cm³, preferably from 100 to 500 F/cm³, more preferably from about 200 F/cm³, to a density current of 2 A/g.

Process of the Invention

The invention also relates to a process for manufacturing a monolith of graphene or its derivatives, preferably a monolith of graphene oxide, more preferably a monolith comprising a chemically reduced graphene oxide structure.

According to one embodiment, the invention relates to a process for manufacturing a graphene monolith or its derivatives, as defined above.

According to one embodiment, the process of the invention comprises:
a step (1) for preparing a monolith of graphene or its derivatives, as described hereinabove; and
a step (2) for functionalizing said monolith obtained at step (1).

According to one embodiment, the process of the invention does not include a reduction step of the monolith as described above, by solvothermy.

Step (1)

According to one embodiment, the process of the invention comprises a first step comprising or consisting of preparing a solution of graphene oxide (GO), preferably an aqueous solution of graphene oxide.

According to one embodiment, the invention relates to a process for the preparation of a chemically reduced monolith of graphene oxide by contacting an aqueous solution of graphene oxide and a reducing agent selected from among hydrazine hydrate, ethylene diamine and 1,4-diaminebutane, in a one-step reaction.

According to one embodiment, the expression “one-step reaction” is intended to mean a chemical reaction that allows both the formation and the chemical reduction of the graphene oxide monolith, preferably from a solution of graphene oxide as described below.

According to one embodiment, the preparation of the graphene oxide solution is carried out at a temperature ranging from 5° C. to 50° C., preferably from 10° C. to 40° C., more preferably at a temperature of about 20° C.

According to one embodiment, the concentration of graphene oxide (GO) in the aqueous solution ranges from 1 mg/mL to 100 mg/mL; preferably from 2 mg/ml to 50 mg/ml, more preferably from 2.5 mg/ml to 10 mg/ml. According to one embodiment, the concentration of graphene oxide (GO) in the aqueous solution ranges preferably from 1 mg/mL to 90 mg/mL, from 1 mg/mL to 80 mg/mL, from 1 mg/mL to 70 mg/mL, from 1 mg/mL to 60 mg/mL, from 1 mg/mL to 50 mg/mL, from 1 mg/mL to 40 mg/mL, from 1 mg/mL to 30 mg/mL, from 1 mg/mL to 20 mg/mL, from 1 mg/mL to 10 mg/mL, or from 1 mg/mL to 5 mg/mL. According to one embodiment, the concentration of graphene oxide (GO) in the aqueous solution is about equal to 1, 2, 3, 4, 5, 6, 7, 8, 9 or 10 mg/mL.

In one embodiment, the aqueous solution of graphene oxide is in a range from 2.5 to 10 mg/mL, preferably 5 mg/mL.

According to one embodiment, step (1) further comprises the addition of metal nanoparticles, preferably gold nanoparticles, in the graphene oxide solution as described above. According to one embodiment, step (1) further comprises the addition of a precursor of metal nanoparticles, preferably gold nanoparticles, in the graphene oxide solution as described above. According to one embodiment, step (1) comprises adding chlorauric acid of formula HAuCl₄. According to one embodiment, the mass of chlorauric acid introduced into the graphene oxide solution as described above, varies according to the nanoparticle loading rate of gold targeted in the final monolith. According to one embodiment, the mass of chloroauric acid introduced into the solution of graphene oxide as described above, is from 1 mg to 100 mg, preferably from 3 mg to 50 mg, more preferably is about 3 mg or 30 mg. According to one embodiment, the mass of chloroauric acid introduced into the graphene oxide solution as described above is preferably from 1 mg to 90 mg, from 1 mg to 80 mg, from 1 mg to 70 mg, 1 mg to 60 mg, 1 mg to 50 mg, 1 mg to 40 mg, 1 mg to 30 mg, 1 mg to 20 mg, or 1 mg to 10 mg. According to one embodiment, the mass of chlorauric acid introduced into the graphene oxide solution as described above is about equal to 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49 or 50 mg.

According to one embodiment, step (1) does not include the addition of metal nanoparticles or its precursors. According to one embodiment, step (1) does not include the addition of gold nanoparticles or its precursors.

According to one embodiment, HAuCl₄ mass is in a range from 0 to 100 mg, preferably from 0 to 50 mg. In one embodiment, this mass can be varied to control the mass of gold nanoparticles and thus, ultimately, the mass of silicon nanowires since gold nanoparticles are the catalysts for the formation of silicon nanowires.

According to one embodiment, step (1) further comprises the use of a reducing agent, preferably a chemical reducing agent.

According to one embodiment, the process for manufacturing the monolith of the invention comprises a first step for the preparation of an aqueous solution of graphene oxide in the presence of a reducing agent, preferably selected from hydrazine hydrate, ethylene diamine or 1,4-diaminebutane. According to one embodiment, the reducing agent is selected from ethylene diamine or 1,4-diaminebutane. According to one embodiment, the reducing agent is not hydrazine or one of its derivatives. According to one embodiment, step (1) does not include reduction step selected from a heat reduction, hydrothermal reduction and/or solvothermy.

According to one embodiment, the invention also relates to a process for manufacturing the graphene/gold nanoparticle composite, which comprises a first step in which an aqueous solution of graphene oxide, HAuCl₄ and a reducing agent is prepared, preferably said reducing agent being selected from hydrazine hydrate, ethylene diamine or 1,4-diaminebutane.

According to one embodiment, the concentration of reducing agent in the graphene oxide solution ranges from 3.6 μl/mg of graphene oxide to 100 μl/mg of graphene oxide; preferably from 3.6 to 90 μl/mg of graphene oxide, from 3.6 to 80 μl/mg of graphene oxide, from 3.6 to 70 μl/mg of graphene oxide, of 3.6 to 60 μL/mg of graphene oxide, 3.6 to 50 μL/mg of graphene oxide, 3.6 to 40 μL/mg of graphene oxide, 3.6 to 30 μL/mg of graphene oxide, 3.6 to 20 μl/mg of graphene oxide, or 3.6 to 10 μl/mg of graphene oxide. In one embodiment, the hydrazine hydrate is in a range between 3.6 μL/mg of graphene oxide and 7.2 μL/mg of graphene oxide. In one embodiment, the ethylene diamine is in a range between 5 μL/mg of graphene oxide and 10 μL/mg of graphene oxide. In one embodiment, 1,4-diaminebutane is in a range of between 5 μL/mg of graphene oxide and 20 μL/mg of graphene oxide.

In one embodiment, the concentration of graphene oxide is greater than 2.5 mg/mL and the concentration of hydrazine hydrate is greater than 3.6 μL/mg. For lower concentrations no monolith is formed and the mixture remains in dispersed form. According to one embodiment, the minimum concentration of graphene oxide is 2.5 mg/ml. According to one embodiment, the minimum concentration of reducing agent is 3.6 μl/mg of graphene oxide.

According to one embodiment, step (1) further comprises a step of mixing (such as by sonification for example), heating, washing, lyophilization and/or drying of the graphene oxide solution such as than previously defined. According to one embodiment, step (1) comprises that the solution is sonic ated, heated, washed, lyophilized and/or dried. According to one embodiment, the formation of the three-dimensional composite (or monolith) and the reduction of graphene oxide are concomitant. According to one embodiment, lyophilization leads to the formation of a hydrogel such as, for example, a hydrazine hydrate-reduced graphene oxide hydrogel (GH-HD), a reduced graphene oxide hydrogel with ethylene diamine hydrate (GH-ED), or a graphene oxide hydrogel reduced by 1,4-diamine butane (GH-DB).

According to one embodiment, the mixture of the aqueous solution of graphene oxide as described above, is carried out for 1 min to 60 min, preferably 5 min to 30 min, more preferably about 10 min. According to one embodiment, the mixture of the aqueous solution of graphene oxide as described above, is implemented for about 1, 2, 3, 4, 5, 6, 7, 8, 9, 10, 11, 12 , 13, 14, 15, 16, 17, 18, 19, 20, 21, 22, 23, 24, 25, 26, 27, 28, 29, 30, 31, 32, 33, 34, 35, 36, 37 , 38, 39, 40, 41, 42, 43, 44, 45, 46, 47, 48, 49, 50, 51, 52, 53, 54, 55, 56, 57, 58, 59 or 60 min. In one embodiment, the sonication of the reagents before heating lasts about 10 minutes.

According to one embodiment, the aqueous solution of graphene oxide as described above, is heated at a temperature ranging from 30° C. to 90° C.; preferably 30° C. to 80° C., 30° C. to 70° C., 30° C. to 60° C., 30° C. to 50° C., or 30° C. to 40° C. According to one embodiment, the aqueous solution of graphene oxide as described above, is heated to a temperature of about 30, 35, 40, 45, 50, 55, 60, 65, 70, 75, 80, 85 or 90° C.

According to one embodiment, the aqueous solution of graphene oxide as described above, is heated for a period of 1 h to 48 h, preferably 1 h to 24 h, more preferably about 24 h. According to one embodiment, the aqueous solution of graphene oxide as described above is heated for a duration of about 1, 2, 3, 4, 5, 6, 7, 8, 9, 10, 11, 12 , 13, 14, 15, 16, 17, 18, 19, 20, 21, 22, 23, 24, 25, 26, 27, 28, 29, 30, 31, 32, 33, 34, 35, 36, 37 , 38, 39, 40, 41, 42, 43, 44, 45, 46, 47 or 48 h. In one embodiment, the heating of the solution is carried out in a closed flask placed in an oil bath at about 80° C. for about 24 hours without stirring.

According to one embodiment, the aqueous solution of graphene oxide as described above, is washed. In one embodiment, the wash consists of successive immersions in distilled water.

According to one embodiment, the aqueous solution of graphene oxide as described above, is freeze-dried (or lyophilized). In one embodiment, lyophilization is carried out at about −37° C.

According to one embodiment, the aqueous solution of graphene oxide as described above is dried after mixing. According to one embodiment, the aqueous solution of graphene oxide as described above, is dried for a period ranging from 1 h to 72 h, preferably 1 h to 48 h, more preferably about 48 h. According to one embodiment, the aqueous solution of graphene oxide as described above, is dried for a duration of about 1, 2, 3, 4, 5, 6, 7, 8, 9, 10, 11, 12 , 13, 14, 15, 16, 17, 18, 19, 20, 21, 22, 23, 24, 25, 26, 27, 28, 29, 30, 31, 32, 33, 34, 35, 36, 37 , 38, 39, 40, 41, 42, 43, 44, 45, 46, 47 or 48 h. According to one embodiment, drying is carried out in the open air. In one embodiment, drying is carried out with air for about 48 hours.

According to one embodiment, drying is carried out by means of an oven or a vacuum oven. According to one embodiment, when drying is carried out by means of an oven or a vacuum oven, the drying temperature ranges from 30° C. to 90° C.; preferably 30° C. to 80° C., 30° C. to 70° C., 30° C. to 60° C., 30° C. to 50° C., or 30° C. to 40° C.; more preferably is about 60° C. According to one embodiment, when drying is carried out by means of an oven or a vacuum oven, the drying temperature is about of 30, 35, 40, 45, 50, 55, 60, 65, 70, 75, 80, 85 or 90° C. In another embodiment, drying is carried out in a vacuum oven at about 60° C., for about 10 hours.

According to one embodiment, the formation of the monolith, the reduction of graphene oxide, and the formation and deposition of metal nanoparticles such as gold nanoparticles in said monolith, are made in a single step.

According to one embodiment, step (1) further comprises a step of removing the residual water contained in the monolith of the invention, after reaction.

Step (2)

According to one embodiment, the process of the invention comprises a step for functionalizing the monolith of the invention as obtained in step (1).

According to one embodiment, the functionalization step comprises or consists of the formation and/or grafting of silicon nanowires in the structure of the monolith obtained at the end of step (1). According to one embodiment, the grafting of silicon nanowires is obtained by diffusion of a precursor gas to the growth of silicon nanowires, preferably a silicon gas, more preferably silane of formula SiH₄, within the structure of said monolith obtained in step (1).

According to one embodiment, the silicon nanowires are interpenetrated in the structure of said monolith. According to one embodiment, the silicon nanowires are grafted with a covalent bond on the surface of the pores of said monolith. According to one embodiment, the silicon nanowires are distributed homogeneously over the entire surface of the pores of said monolith.

According to one embodiment, the growth of the silicon nanowires is obtained by placing said monolith in a suitable furnace, in particular in a low pressure chemical vapor deposition (LPCVD) furnace type, at high temperature in the presence of a gaseous silicon mixture.

According to one embodiment, the silicon nanowires are not adsorbed on the surface of the monolith obtained in step (1).

According to one embodiment, the invention also relates to a process of manufacturing a graphene/silicon nanowire composite, which is a porous monolith, in which the silicon nanowires are homogeneously distributed in the monolith and in which the two components are closely linked. In a first step, a graphene/gold nanoparticle composite, which is a porous monolith in which the gold nanoparticles are homogeneously distributed in the monolith, is prepared and in a second step, said monolith is placed in a suitable oven, such as LPCVD furnace type, at high temperature in the presence of a silicon gaseous mixture. According to one embodiment, the functionalization step of the monolith obtained at the end of step (1) is carried out in an oven. In one embodiment, the graphene monolith decorated with gold nanoparticles is placed in a quartz crucible placed in the center of the furnace.

According to one embodiment, the step of functionalization of the monolith obtained at the end of step (1) is carried out at a temperature ranging from 400 to 1000° C., preferably from 500 to 800° C., more preferably of about 650° C. According to one embodiment, the functionalization step of the monolith obtained at the end of step (1) is carried out at a temperature ranging from 450 to 1000° C., preferably from 450 to 900° C., from 450 to 850° C., from 450 to 800° C., from 450 to 750° C., from 450 to 700° C., from 450 to 650° C., from 450 to 600° C., from 450 to 550° C. or from 450 to 500° C.

According to one embodiment, the functionalization step of the monolith obtained at the end of step (1) is carried out in the presence of a gas or a gaseous mixture. In one embodiment, the gaseous mixture comprises a silicon gas, preferably SiH₄, potentially an additional gas, preferably HCl, and a carrier gas, preferably H₂.

According to one embodiment, the silicon gas has a flow rate from 10 to 100 cm³/min, preferably 40 cm³/min According to one embodiment, the silicon gas has a flow rate of 10 to 90 cm³/min, preferably from 20 to 90, from 30 to 90, from 40 to 90, from 50 to 90, from 60 to 90, from 70 to 90, or from 80 to 90 cm³/min In one embodiment, the silicon gas has a flow rate of about 10, 15, 20, 25, 30, 35, 40, 45, 50, 55, 60, 65, 70, 75, 80, 85, 90, 95 or 100 cm³/min

According to one embodiment, the additional gas has a flow rate from 50 to 500 cm³/min, preferably 100 cm³/min. According to one embodiment, the additional gas has a flow rate of 50 to 450 cm³/min; preferably from 50 to 400, from 50 to 350, from 50 to 300, from 50 to 250, from 50 to 200, from 50 to 150, or from 50 to 100 cm³/min

According to one embodiment, the additional gas has a flow rate of about 50, 60, 70, 80, 90, 100, 110, 120, 130, 140, 150, 160, 170, 180, 190, 200, 210, 220, 230, 240, 250, 260, 270, 280 , 290, 300, 310, 320, 330, 340, 350, 360, 370, 380, 390, 400, 410, 420, 430, 440, 450, 460, 470, 480, 490 or 500 cm³/min. In this embodiment, the use of an additional gas makes it possible to obtain homogeneous silicon nanowires in sizes and diameters.

According to one embodiment, the carrier gas has a flow rate from 0.5 to 4 L/min, preferably 1 L/min. According to one embodiment, the carrier gas has a flow rate of about 0.5; 1; 1.5; 2; 2.5; 3; 3.5 or 4 L/min. In this embodiment, the presence of the carrier gas H₂ allows obtaining reduced silicon, and not its oxidized form SiO₂.

According to one embodiment, the functionalization step further comprises the use of a doping gas, preferably selected from phosphine or diborane, to dope the nanowires n or p, respectively, and thus make them more conductive. In one embodiment, the doping is intense and greater than 10¹⁹ cm⁻³ in order to eliminate the serial resistance of the storage component.

According to one embodiment, the pressure is from 500 to 1400 Pa, preferably from 650 to 940, more preferably of about 800 Pa.

According to one embodiment, the reaction time ranges from 15 to 60 min, preferably about 20 min. According to one embodiment, the reaction time ranges from 15 to 55 min, 15 to 50 min, 15 to 45 min, 15 to 40 min, 15 to 35 min, 15 to 30 min, 15 to 25 min or 15 to 20 min. It may be interesting to vary the duration of the reaction depending on the applications, since it makes it possible to control the length of silicon nanowires in graphene.

Advantages of the Process

According to one embodiment, the process of the invention makes it possible to obtain a monolith based on graphene or on three-dimensional graphene oxide.

According to one embodiment, the process of the invention makes it possible to obtain a monolith based on graphene or three-dimensional graphene oxide having a high degree of reduction with a C/O ratio ranging from 1 to 50, preferably from 10 to 25, more preferably of about 16.7. According to one embodiment, the C/O ratio of the monolith of the invention is about 1, 2, 3, 4, 5, 6, 7, 8, 9, 10, 11, 12, 13, 14, 15 , 16, 17, 18, 19, 20, 21, 22, 23, 24, 25, 26, 27, 28, 29, 30, 31, 32, 33, 34, 35, 36, 37, 38, 39, 40 , 41, 42, 43, 44, 45, 46, 47, 48, 49 or 50. According to one embodiment, the C/O ratio of the monolith of the invention ranges preferably from 1 to 50, from 1 to 40, from 1 to 30, from 1 to 20, or from 1 to 10. According to one embodiment, the C/O ratio of the monolith of the invention is preferably from 5 to 50, from 10 to 50, from 15 to 50, 20 to 50, 25 to 50, 30 to 50, 35 to 50, 40 to 50, or 45 to 50.

According to one embodiment, the process of the invention allows obtaining a monolith based on graphene or three-dimensional graphene oxide having a porous structure and a high specific surface area ranging from 50 to 5000 m²/g, preferably 800 to 2500, more preferably 1 433 m²/g. According to one embodiment, the specific surface area of the monolith of the invention ranges from 50 to 5000 m²/g; preferably from 50 to 4000, from 50 to 3000, from 50 to 2000, from 50 to 1000, from 50 to 500, from 50 to 400, from 50 to 300, from 50 to 200, or from 50 to 100 m²/g. According to one embodiment, the specific surface area of the monolith of the invention is from 1000 to 2500 m²/g; preferably from 1100 to 2500, from 1200 to 2500, from 1300 to 2500, from 1400 to 2500, from 1500 to 2500, from 1600 to 2500, from 1700 to 2500, from 1800 to 2500, from 1900 to 2500, from 2000 to 2500, 2500, from 2100 to 2500, from 2200 to 2500, from 2300 to 2500, or from 2400 to 2500 m²/g.

According to one embodiment, the process of the invention allows obtaining a monolith based on graphene or on three-dimensional graphene oxide having a low resistance to charge transfer. According to one embodiment, the charge transfer resistance ranges from 0.1 to 5Ω, preferably from 0.3 to 1.5Ω, more preferably is about 0.62Ω. According to one embodiment, the charge transfer resistance ranges preferably from 0.1 to 4Ω, from 0.1 to 3Ω, from 0.1 to 2Ω, or from 0.1 to 1Ω. According to one embodiment, the charge transfer resistance is about 0.1; 0.2; 0.3; 0.4; 0.5; 0.6; 0.7; 0.8; 0.9 or 152.

According to one embodiment, the process of the invention allows obtaining a graphene which is three-dimensional, which has a high degree of reduction with a C/O ratio ranging from 1 to 50, preferably from 10 to 25, more preferably from 16.7, which has a porous structure and a high specific surface area ranging from 50 to 5000, preferably 800 to 2500, more preferably is about 1433 m²/g and which has a low charge transfer resistance ranging from 0.1 to 5Ω, preferably from 0.3 to 1.5Ω, more preferably of about 0.62Ω.

According to one embodiment, the process of the invention makes it possible to produce a graphene monolith which has a large micro, meso and macro-metric porosity which will facilitate the diffusion of the gases responsible for the growth of the silicon nanowires within the structure and thus optimized interpenetration of silicon nanowires and which will facilitate the establishment of a strong physicochemical link between silicon nanowires and their growth matrix.

According to one embodiment, the measurement of the specific surface area has been obtained by methylene blue dye uptake studies. This specific surface differs from the BET surface not measured here. In one embodiment, the pores have a diameter in the range of one nanometer to 500 microns. The pore diameters were obtained by scanning electron microscopy. The pore size observed by SEM is 0.1 to 30 microns.

Graphene according to the invention has the advantage of having a high electrical conductivity ranging from 10 to 2500 S/m, preferably from 950 to 1500, more preferably of 1141 S/m. According to one embodiment, the electrical conductivity of the monolith of the invention ranges preferably from 100 to 2500 S/m, from 200 to 2500, from 300 to 2500, from 400 to 2500, from 500 to 2500, from 600 to 2500, from 700 to 2500, from 800 to 2500, from 900 to 2500, from 1000 to 2500, from 1100 to 2500, from 1200 to 2500, from 1300 to 2500, from 1400 to 2500, from 1500 to 2500, from 1600 to 2500, from 1700 to 2500, from 1800 to 2500, from 1900 to 2500, from 2000 to 2500, from 2100 to 2500, from 2200 to 2500, from 2300 to 2500, or from 2400 to 2500 S/m. According to one embodiment, the electrical conductivity of the monolith of the invention is about 1830 S/m.

Electrical conductivity values were obtained using a four-point measurement technique. Tablets prepared by pressing a piece of gel under 10 MPa were used for these measurements.

The process of the invention allows preparing a graphene/gold nanoparticle composite which has a large micro-, meso- and macro-porosity porosity which facilitates the distribution of the gold nanoparticles and the diffusion of the gases responsible for the growth of the silicon nanowires within the structure and therefore the optimized interpenetration of silicon nanowires and which will facilitate the establishment of a strong physicochemical link between the silicon nanowires and their growth matrix. Furthermore, the process of the invention allows preparing a graphene/gold nanoparticle composite which has a significant macro and meso-metric porosity which facilitates the homogeneous deposition of gold nanoparticles catalyzing the growth of silicon nanowires.

Thus, the process of the invention has the advantage of producing graphene composites/silicon nanowires:
for which the composite is a three-dimensional monolith,
for which the process for reducing graphene oxide and forming the monolith is a one-step process,
for which the 2 components are mixed homogeneously,
for which the 2 components are intimately linked, that is to say with a physicochemical link,
for which graphene is a porous monolith,
for which the silicon nanowire increases so as not to have SiO2 on the surface,
for which the growth process of the nanowires simultaneously produces a further reduction of the composite.

Uses

The present invention also relates to the use of the process or of the monolith as described above.

According to one embodiment, the monolith of the invention is useful for the manufacture of high electrical conductivity material, preferably suitable for energy storage applications such as lithium-ion batteries or supercapacitors.

The present invention also relates to a battery comprising the monolith of the invention. The present invention also relates to a supercapacity comprising the monolith of the invention.

According to one embodiment, the supercapacity comprises two slices of monoliths of the invention, preferably of the same mass and/or dimensions. According to one embodiment, the supercapacity further comprises nickel foams, filter paper, an electrolyte such as for example a potassium hydroxide (KOH) solution, and/or at least one electrode. According to one embodiment, the supercapacity of the invention comprises as electrolyte a solution of potassium hydroxide (KOH) at a concentration of 6 mol /L. According to one embodiment, the supercapacity of the invention has a Swagelok type structure.

According to one embodiment, the supercapacity has a capacity from 1 to 500 F/g, preferably from 100 to 300 F/g, more preferably about equal to 190 F/g. According to one embodiment, the supercapacity has a capacity from 10 to 500 F/g; preferably from 50 to 500 F/g, from 100 to 500 F/g, from 150 to 500 F/g, from 200 to 500 F/g, from 250 to 500 F/g, from 300 to 500 F/g, from 350 to 500 F/g, from 400 to 500 F/g, or from 450 to 500 F/g. According to one embodiment, the supercapacity has a capacity ranging from 10 to 450 F/g; preferably from 10 to 400 F/g, from 10 to 350 F/g, from 10 to 300 F/g, from 10 to 200 F/g, or from 10 to 100 F/g. According to one embodiment, the supercapacity has a capacity of about 100, 110, 120, 130, 140, 150, 160, 170, 180, 190, 200, 210, 220, 230, 240, 250, 260, 270, 280, 290 or 300 F/g. According to one embodiment, the supercapacity has a capacity of about 190 F/g at a current density of 0.5 A/g. According to one embodiment, the supercapacity has a capacity of about 123 F/g at a current density of 100 A/g.

According to one embodiment, the supercapacity has a high power density. According to one embodiment, the supercapacity has a power density ranging from 1 to 100 kW/kg, preferably from 10 to 50 kW/kg, more preferably from about 38 kW/kg. According to one embodiment, the supercapacity has a power density ranging from 10 to 100 kW/kg, 20 to 100 kW/kg, 30 to 100 kW/kg, 40 to 100 kW/kg, 50 to 100 kW/kg, 60 to 100 kW/kg, 70 to 100 kW/kg, 80 to 100 kW/kg, or 90 to 100 kW/kg. According to one embodiment, the supercapacity has a power density ranging from 10 to 90 kW/kg, 10 to 80 kW/kg, 10 to 70 kW/kg, 10 to 60 kW/kg, 10 to 50 kW/kg, 10 to 40 kW/kg, 10 to 30 kW/kg, or 10 to 20 kW/kg. According to one embodiment, the supercapacity has a power density of about 10, 15, 20, 25, 30, 35, 40, 45, 50, 55, 60, 65, 70, 75, 80, 85, 90, 95 or 100 kW/kg.

According to one embodiment, the supercapacity provides an energy density ranging from 1 to 100 Wh/kg, preferably 10 to50 Wh/kg, more preferably of about 4.3 Wh/kg. According to one embodiment, the supercapacity provides an energy density ranging from 10 to 100 Wh/kg, preferably 10 to 90 Wh/kg, 10 to 80 Wh/kg, 10 to 70 Wh/kg, 10 to 60 Wh/kg, 10 to 50 Wh/kg, 10 to 40 Wh/kg, 10 to 30 Wh/kg, or 10 to 20 Wh/kg. According to one embodiment, the supercapacity provides an energy density ranging from 20 to 100 Wh/kg, from 30 to 90 Wh/kg, from 40 to 100 Wh/kg, from 50 to 100 W Wh/kg, from 60 to 100 Wh/kg, from 70 to 100 Wh/kg, from 80 to 100 Wh/kg, or from 90 to 100 Wh/kg.

According to one embodiment, the supercapacity has a power density ranging from 1 to 100 kW/kg while providing an energy density ranging from 1 to 100 Wh/kg. According to one embodiment, the supercapacity has a power density of about 38 kW/kg while providing an energy density of 4.3 Wh/kg.

According to one embodiment, the supercapacitor or the battery of the invention has a gravimetric discharge capacity ranging from 1 to 300 F/g, preferably 10 to 150 F/g, more preferably about 130 F/g. According to one embodiment, the supercapacity or the battery of the invention has a gravimetric discharge capacity of about 10, 20, 30, 40, 50, 60, 70, 80, 90, 100, 110, 120, 130, 140, 150, 160, 170, 180, 190, 200, 210, 220, 230, 240, 250, 260, 270, 280, 290 or 300 F/g.

According to one embodiment, the supercapacitor or the battery of the invention has a volumetric discharge capacity ranging from 1 to 500 F/cm³, preferably 100 to F/cm³, more preferably about 200 F/cm³. According to one embodiment, the supercapacitor or the battery of the invention has a volumetric discharge capacity of about 1, 10, 20, 30, 40, 50, 60, 70, 80, 90, 100, 110, 120, 130, 140, 150, 160, 170, 180, 190, 200, 210, 220, 230, 240, 250, 260, 270, 280, 290, 300, 310, 320, 330, 340, 350, 360, 370, 380, 390, 400, 410, 420, 430, 440, 450, 460, 470, 480, 490 or 500 F/cm³. According to one embodiment, the supercapacitor or the battery of the invention has a volumetric discharge capacity ranging from 1 to 500 F/cm³, preferably from 100 to 500 F/cm³, more preferably about 200 F/cm³, at a current density of 2A/g.

According to one embodiment, the supercapacitor or the battery of the invention has excellent electrical conductivity. According to one embodiment, the supercapacitor or the battery of the invention can quickly transfer the charges to the electrode/electrolyte interface. According to one embodiment, the supercapacitor or the battery of the invention allows a faster ion diffusion of the electrodes.

According to one embodiment, the supercapacitor or the battery of the invention has excellent cyclic stability. According to one embodiment, the supercapacitor or the battery of the invention has a capacity retention of more than 10%, preferably from 10% to 100%, more preferably from 50% to 95%. According to one embodiment, the supercapacitor or the battery of the invention has a capacity retention ranging from 60% to 100%, preferably from 80% to 99%, more preferably from 90% to 99%. According to one embodiment, the supercapacitor or the battery of the invention has a capacity retention of about 5, 10, 15, 20, 25, 30, 35, 40, 45, 50, 55, 60, 65, 70, 75, 80, 85, 90, 95 or 100%. According to one embodiment, the supercapacitor or the battery of the invention has a capacity retention of about 93%. According to one embodiment, the supercapacitor or battery of the invention has a capacity retention of about 93% after 2000 cycles. According to one embodiment, the supercapacity or battery of the invention has a capacity retention of about 93% after 2000 cycles at a current density of 10 A/g.

According to one embodiment, the supercapacitor or the battery of the invention has a capacity retention of 100% after 5000 cycles. According to one embodiment, the supercapacitor or the battery of the invention has a capacity retention of 100% after 5000 cycles at a current density of 2 A/g.

According to one embodiment, the electrical conductivity of the supercapacitor or of the battery of the invention is preferably from 100 to 2500 S/m, from 200 to 2500, from 300 to 2500, from 400 to 2500, from 500 to 2500, from 600 to 2500, from 700 to 2500, from 800 to 2500, from 900 to 2500, from 1000 to 2500, from 1100 to 2500, from 1200 to 2500, from 1300 to 2500, from 1400 to 2500, from 1500 to 2500, from 1600 to 2500, from 1700 to 2500, from 1800 to 2500, from 1900 to 2500, from 2000 to 2500, from 2100 to 2500, from 2200 to 2500, from 2300 to 2500, or from 2400 to 2500 S/m. According to one embodiment, the electrical conductivity of the supercapacitor or the battery of the invention is about 1830 S/m.

According to one embodiment, the supercapacitor or the battery of the invention has a current density ranging from more than 0 to 10 A/g, preferably 1 to 5 A/g, more preferably about 2 A/g. According to one embodiment, the supercapacity or battery of the invention has a current density of about 1, 2, 3, 4, 5, 6, 7, 8, 9 or 10 A/g. According to one embodiment, the supercapacitor or the battery of the invention has a current density ranging from 1 to 10 A/g, preferably from 1 to 9 A/g, from 1 to 8 A/g, from 1 to 7 A/g, from 1 to 6 A/g, from 1 to 5 A/g, from 1 to 4 A/g, from 1 to 3 A/g, or from 1 to 2 A/g.

### BRIEF DESCRIPTION OF THE DRAWINGS

FIG. 1 is a photograph showing the scheme of the process for preparing gels with different diamines used as reducing agent.

FIG. 2 is a table showing the elemental composition and the C/O ratio of GH-HD obtained from X-ray photoelectron spectroscopy, the electrical conductivity (σ) of GH-HD and the discharge capacities of GH-HD (C_{wt}) in F/g at different rates.

FIG. 3 is a set of 2 scanning electron microscopy images (a and b) of GH-HD 3D structures.

FIG. 4 is a graph showing a comparison of energy and power densities of GH-HD and GH-ED with references of the literature where graphene-based materials are obtained by various reduction techniques.

FIG. 5 is a graph showing a cyclic stability study of GH-HD showing discharge capacities after 5000 cycles when performed at a current density of 2 A/g.

FIG. 6 is a graph showing the specific capacity (expressed in F/cm³) of GH-HD and CMG in function of current density (expressed in A/g).

FIG. 7 is a graph showing the cyclic stability of GH-HD and its densified compound GH-HD-AD obtained at a current density of 2 A/g, during 5000 cycles.

### EXAMPLES

The present invention is further illustrated by the following examples which illustrate, without limitation, the methods of the invention.

### Example 1

### Preparation of Graphene Monolith Decorated with Gold Nanoparticles with Hydrazine Hydrate as Reducing Agent

An aqueous solution of graphene oxide (GO) is prepared in a range from 2.5 to 10 mg/mL, usually 5 mg/mL. A mass of HAuCl₄ is added, which will depend on the gold nanoparticle loading rate of the final system, for example, 3 or 30 mg. Hydrazine hydrate is added between 3.6 μL,/mg of GO and 7.2 μL/mg of GO (at lower concentrations the monolith is not formed). The solution is sonicated for about 10 minutes. The flask is closed, placed in an oil bath and heated, without stirring, at about 80° C. for about 24 hours. A block of graphene is obtained, which is then washed by successive immersions in distilled water, freeze-dried at −37° C., then air-dried for about 48 hours, and then heated again in a vacuum oven. at about 60° C., for about one night. The formation of the monolith, the reduction of graphene oxide, and the deposition of gold particles are carried out concomitantly in a one-step process.

It should be noted that under conditions of GO concentration lower than 2.5 mg/mL and hydrazine hydrate of less than 3.6 μL/mg of GO no monolith is formed and the mixture remains in dispersed form after reaction.

After the reaction, the liquid is removed, and the graphene block is immersed in water for about 30 minutes to dissolve the unreacted hydrazine hydrate. This immersion is repeated at least 3 times. The block is then lyophilized and then dried in a vacuum oven. In its dry form, the block can be broken and cut into pieces.

### Example 2

### Preparation of Graphene Monolith Decorated with Gold Nanoparticles with Ethylene Diamine as Reducing Agent

The same operating conditions as those described hereinabove are used. Only the amount of ethylene diamine varies between 5 μL/mg of GO and 10 μL/mg of GO.

### Example 3

### Preparation of Graphene Monolith Decorated with Gold Manoparticles with 1,4-Diamine Butane as Reducing Agent

The same operating conditions as those described hereinabove are used. Only the quantity of 1,4-diamine butane varies between 5 μL/mg of GO and 20 μL/mg of GO.

### Example 4

### Preparation of Gold-Free Graphene Monolith with Hydrazine Hydrate, Ethylene Diamine or 1,4-Diamine Butane as Reducing Agents

The same operating conditions as those described above are used, without HAuCl₄. After the lyophilization phase, hydrogels are obtained: GH-HD with hydrazine hydrate, GH-ED with ethylene diamine and GH-DB with 1,4-diamine butane.

A dense hydrogel GH-HD-AD is obtained after air drying of GH-HD.

FIG. 1 shows the scheme of the formation process of gels with different diamines used as reducing agent.

The technical characteristics of GH-HD and GH-HD-AD are presented below in the results section.

### Example 5

### Growth of Silicon Nanowires

A piece of graphene monolith decorated with gold nanoparticles as obtained in Examples 1, 2 or 3 is placed in a quartz crucible placed at the center of an LPCVD furnace. Growth is carried out at a temperature of around 650° C. with a reactive gas SiH₄ (flow rate about 40 cm³/min), an additional HCl gas (flow rate at 100 cm³/min about) and an H₂ carrier gas (flow at about 1 L/min). The total working pressure is about 6 Torr. The reaction time is about 20 minutes. This last criterion is only important for the length of the silicon nanowires.

### Example 6

### Supercapacities Manufacturing

The GH-HD graphene monoliths as obtained in Example 4 are cut into several slices about 1 mm thick. Two slices of the monolith, of the same mass, are pressed on nickel foams under a pressure of 10 MPa. A piece of filter paper (Whatman filter paper) was used as a separator between the electrodes. Electrodes and filter paper, quenched overnight in 6M KOH electrolyte, were assembled in a layered structure in a Swagelok-type two-electrode cell configuration with stainless steel as the current collector.

The technical characteristics of the supercapacitor obtained are presented below in the results section.

Materials and Methods

Electrochemical Measurements

The supercapacitor performance of Example 6 was evaluated using cyclic voltammetry, galvanostatic charge-discharge cycles, and electrochemical impedance spectroscopy.

A VMP3 multi-channel potentiostat/galvanostat equipped with EC-Lab software (Biologic) was used for all electrochemical techniques.

The cyclic voltammetry and charge-discharge measurements were made between 0 and 1 V with scanning rates from 100 mV/s to 1000 mV/s and from 0.5 A/g to 100 A/g respectively.

The electrochemical impedance spectroscopy test was performed in a frequency range between 400 kHz and 40 mHz and an AC disturbance of 10 mV.

The gravimetric capacitances (C_{wt}) of graphene monoliths derived from galvanostatic discharge curves were calculated using the equation: C_{wt}=2 I/m (ΔV/Δt)), where I is the constant discharge current, m is the mass of an electrode and ΔV and Δt represent the voltage change (except for V_{drop}) on the discharge and the full discharge time, respectively.

The corresponding volumetric capacities (Cᵥₒₗ) were calculated as follows: Cᵥₒₗ=C_{wt}×ρ, where ρ is the conditioning density of graphene.

Gravimetric energy (E_{wt}) and power densities (P) were calculated as E_{wt}=C_{wt}V2/8 and P=E_{wt}/Δt.

Conditioning densities were obtained by calculating the dried gel mass with an accuracy of 0.01 mg and measuring the dimensions using scanning electron microscopy.

Technical Characterizations

A Metler-Toledo XPE205 weighing scale was used to obtain the weight of the samples with an accuracy of 0.01 mg.

The modifications of the chemical bond were analyzed by Fourier Transform Infrared Spectroscopy (FT-IR, Thermofischer ES 50) in the frequency range from 4000 to 400 cm⁻¹.

The materials were tested with KBr pellet.

The crystallographic structures of the materials were determined by a Wide Angle X-Ray Diffraction (XRD) system on a Panalytical X′pert PRO X-ray diffractometer using a Co Kα radiation source (λ=1.79 Å).

Thermogravimetric analysis (TGA) of all samples was performed with Setaram TGA 92 equipment with a heating ramp of 5° C./minute over a temperature range of 30° C. to 800° C. under a nitrogen atmosphere.

Electrical conductivity values were obtained using a four-point measurement technique. Pellets prepared by pressing a piece of gel under 10 MPa were used for these measurements.

Conditioning densities were also calculated by measuring the mass and volume of these films.

X-ray photoelectron spectroscopy (XPS) analyzes were performed using a Versa Probe II PHI spectrometer with a monochromatized (1 486.6 eV) Al Kα X-ray source focused on a 100 μm spot and with an electronic take-off angle of Θ=45°.

Global spectra of photoelectrons were recorded with a pass energy of 117 eV and high resolution spectra with a pass energy of 23.5 eV. Deconvolution of the C1s and N1s level spectra was performed by fitting the individual components to values obtained from previous reports using the Casa XPS software. The spectra were adjusted in Gauss-Lorentz curves with maximum values of total width less than 1.5 in all cases.

The morphology of graphene monoliths was characterized using a Zeiss Ultra 55 electron microscope at an acceleration voltage of 7 kV.

Results

GH-HD

The physical and chemical properties of the GH-HD graphene monoliths of Example 4 were characterized by FT-IR, TGA, XRD, XPS and conductivity measurements. Scanning electron microscopy was performed to analyze the three-dimensional structures.

Analysis of the GH-HD samples synthesized with the optimized reaction conditions of Example 4 revealed that the resulting hydrogels are exceptionally conductive with excellent power capabilities. In addition, instead of using large amounts of hydrazine monohydrate as described in the literature, one simply uses a molar equivalent of reducing agent corresponding to the amount of graphene oxide used.

Hydrazine, which is a strong reducing agent, promotes the formation of the monolith via the assembly of reduced graphene oxide by non-covalent interactions such as π-π interactions. The synthesized GH-HD therefore has a high degree of reduction with a significant C/O ratio of 16.7 (see FIG. 2), an interlayer spacing of 3.76 Å and a thermal behavior identical to graphite.

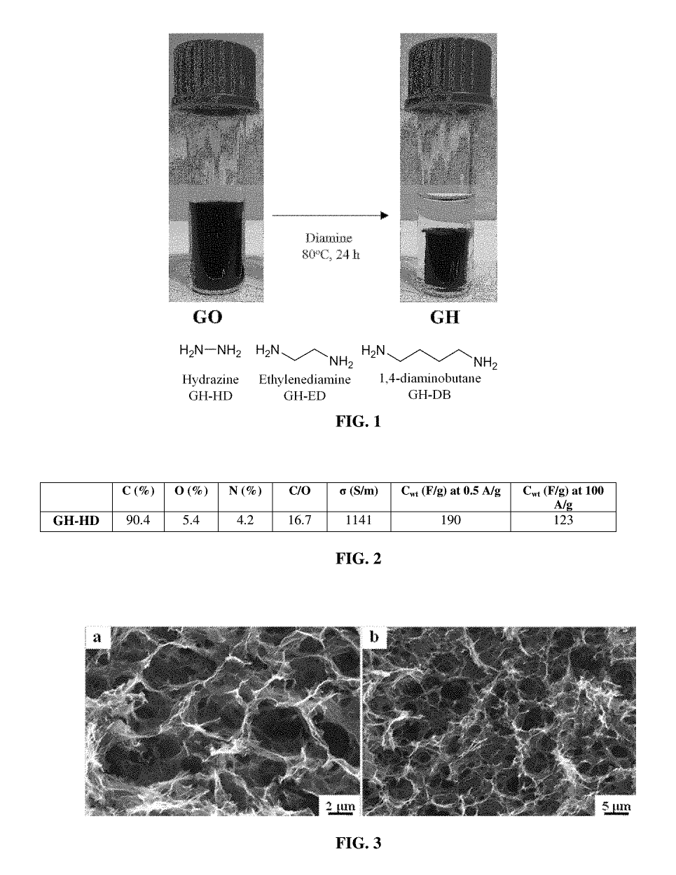

GH-HD has a porous morphology (see FIG. 3) and has a high specific surface area of 1433 m²/g.

The macroporous network also allows a high conductivity of GH-HD of 1141 S/m (see FIG. 2).

Finally, the synthesized GH-HD has a low resistance to charge transfer of 0.62Ω offering real high-speed performance.

The synthesis process according to the invention is very simple, in one step, and makes it possible to obtain these very reduced graphene monoliths which are likely to be used in lithium ion batteries and low cost supercapacitors having high powers.

Supercapacitor

The synthesized GH-HD was tested in a supercapacitor configuration according to Example 6.

Charge transfer and ion transfer within the highly conductive and porous GH-HD have been found to be responsible for the good electrochemical performance of supercapacitor.

The synthesized GH-HD, in supercapacitor configuration, demonstrates high capacities of 190 F/g at a current density of 0.5 A/g and 123 F/g at a current density of 100 A/g (see FIG. 2).

These performances are attributed, on the one hand, to three-dimensional networks with large pore volumes that facilitate the rapid transfer of ions on the electrode interface, on the other hand, to the excellent electrical conductivity of GH-HD which allows fast charge transfer to the electrode/electrolyte interface.

These results corroborate the positive impact of the electrical conductivity and the porosity of GH-HD on the charge transfer and the ion diffusion of the electrodes.

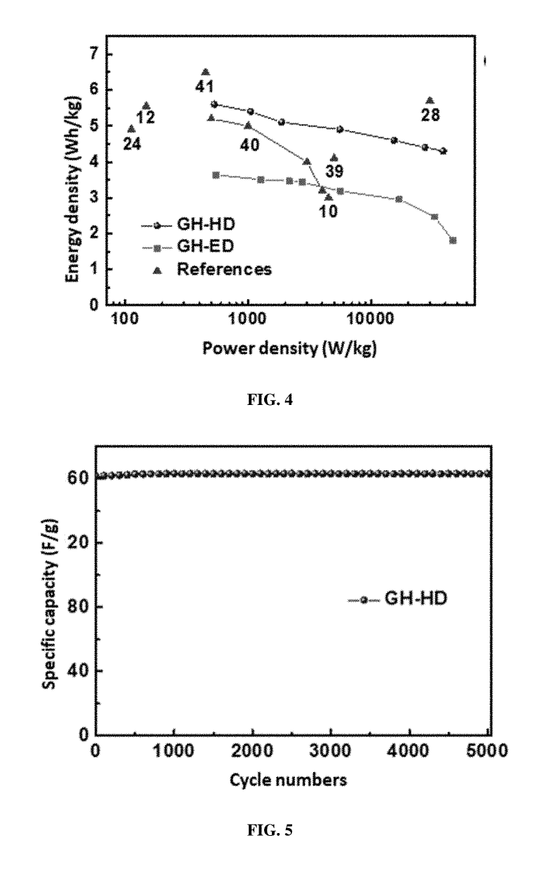

When recycled at a high current density of 100 A/g, with a secondary discharge time of 0.4 s, GH-HD in supercapacitor configuration offers a high power density of 38 kW/kg while providing an energy density of 4.3 Wh/kg (see FIG. 4). GH-HD thus exceeds the graphene monoliths obtained by reduction of graphene oxide by hydrothermal treatment, heat treatment and L-glutathione.

Finally, GH-HD in supercapacitor configuration exhibits excellent cyclic stability with a 93% capacity retention observed after 2000 cycles at a high current density of 10 A/g. Full capacity retention was observed after 5000 cycles at a current density of 2 A/g (see FIG. 5).

Graphene Oxide Reduced with Gaseous Hydrazine (CMG)

CMG was synthesized under reaction conditions similar to those of GH-HD of Example 4 with continuous stirring (ESI procedures).

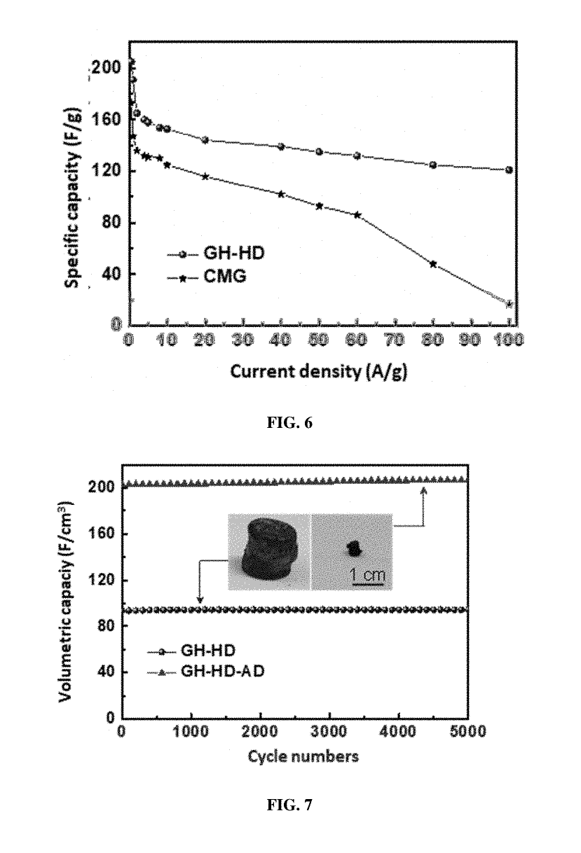

CMG has an electrical conductivity of 1832 S/m, which is higher than that of GH-HD (1141 S/m); this can be understood by improving the reduction in homogenized reaction media. FIG. 6 shows the specific capacity of GH-HD and CMG in function of current density.

GH-HD Densified Gel (GH-HD-AD)

Finally, given the importance of good volumetric capacitances for compact supercapacitors, we synthesized a dense GH-HD gel by following a simple drying procedure.

After hydrazine gel synthesis, the GH-HD was densified from a density of 0.58 g/cm³ to 1.56 g/cm³ by drying under ambient conditions. The gradual removal of the water molecules from the inter-layer spaces reduces the gel to nearly one-tenth of its original size.

FIG. 7 shows the cyclic stability of GH-HD and its densified counterpart GH-HD-AD at a current density of 2 A/g. GH-HD-AD provides gravimetric and volumetric discharge capacities of 130 F/g and 200 F/cm³ respectively at a high current density of 2 A/g.

Although gravimetric capabilities are typically used as a criterion for evaluating supercapacitors, volumetric capacity is considered a crucial measure for compact portable applications. By a simple drying technique, it is possible to double the volumetric capacity of freeze-dried GH-HD from 110 F/cm³ to 257 F/cm³ at a current density of 0.5 A/g.

1. Process of manufacturing a three-dimensional material comprising a monolith of chemically reduced graphene oxide, in which silicon nanowires and gold nanoparticles are dispersed, said process comprising:
a step (1) for manufacturing a monolith of chemically reduced graphene oxide in which gold nanoparticles are dispersed, and
a step (2) for functionalizing said monolith obtained at step (1), in which silicon is grafted on the surface of said monolith, and for which said monolith is brought to a temperature ranging from 500 to 850° C. in the presence of a silicon gas.

2. Process according to claim 1, wherein the chemically reduced graphene oxide monolith in which gold nanoparticles are dispersed (step 1) is prepared by contacting an aqueous solution of graphene oxide, HAuCl₄ and a reducing agent selected from hydrazine hydrate, ethylene diamine and 1,4-diaminebutane, in a one-step reaction.

3. Process according to claim 1, wherein the functionalization of the chemically reduced graphene oxide monolith in which gold nanoparticles are dispersed (step 2) is carried out by heating said monolith in an LPCVD furnace in the presence of: silicon reactive gas; an additional gas; and a carrier gas; at a pressure in a range of 500 to 1400 Pa.

4. Process for the preparation of a chemically reduced graphene oxide monolith by contacting an aqueous solution of graphene oxide with a reducing agent selected from hydrazine hydrate and ethylene diamine and 1,4-diaminebutane, in a one-step reaction.

5. Chemically reduced graphene oxide monolith, obtainable by the process according to claim 1.

6. Chemically reduced graphene oxide monolith according to claim 5, wherein the chemically reduced graphene oxide monolith:
has a high degree of reduction with a C/O ratio ranging from 1 to 50,
is porous with a specific surface area ranging from 50 to 5000 m²/g, and
has a low resistance to charge transfer ranging from 0.1 to 5Ω.

7. Monolith according to claim 5, wherein the pores have a diameter ranging from about 1 nanometer to 500 microns.

8. Monolith according to claim 5, wherein the electrical conductivity is from 10 to 2500.

9. Chemically reduced graphene oxide monolith according to claim 5, in which the gravimetric discharge capacity is from 1 to 300 F/g.

10. Lithium-ion battery comprising a monolith according to claim 5.

11. Supercapacitor comprising a monolith according to claim 5.

12. Lithium-ion battery according to claim 10, having a capacity retention ranging from 80% to 99%.

13. Lithium-ion battery according to claim 10, having a volumetric discharge capacity ranging from 100 to 500 F/cm³.

14. Lithium-ion battery according to claim 10, having a power density ranging from 1 to 100 kW/kg.

15. The process of claim 1, wherein in the step (2), the silicon is in the form of silicon nanowires.

16. The process of claim 15, wherein the monolith is brought to a temperature ranging from 600 to 800° C.

17. The process of claim 15, wherein the monolith is brought to a temperature ranging of about 650° C.

18. The process of claim 3, wherein the silicon reactive gas is SiH₄.

19. The process of claim 18, wherein the additional gas is an acid gas.

20. The process of claim 19, wherein the additional gas is HCl.
